(19) United States
(12) Patent Application Publication
(10) Pub. No.: US 2007/0174181 A1
(43) Pub. Date: Jul. 26, 2007

(54) Method and system for providing foreign exchange price information and hedge

(76) Inventors: Randall Brummette, Hoboken, NJ (US); Kevin Forbes, Garden City, NY (US)

Correspondence Address: STROOCK & STROOCK & LAVAN LLP, 180 MAIDEN LANE, NEW YORK, NY, 10038, US

(21) Appl. No.: 11/712,747

(22) Filed: Feb. 28, 2007

Related U.S. Application Data
(62) Division of application No. 10/081,460, filed on Feb. 21, 2002.

(51) Int. Cl. G06Q 40/00

(52) U.S. Cl. 705/37; 705/35

(57) ABSTRACT

Methods and systems for providing foreign exchange price information and entering into foreign exchange transactions are disclosed. In certain embodiments, a price provider receives foreign exchange rates and, based thereon, provides clients with foreign exchange indicative rates. Such indicative rats are preferably in the form of a streaming price feed. Clients, in turn, may use the indicative rates to revalue existing positions or translate offers in multiple currencies. Additionally, the client can enter into trades with the price provider based on the indicative rates or deal rates generated by the price provider.

### CROSS-REFERENCE TO RELATED APPLICATIONS

This application is a Divisional patent application of pending U.S. patent application Ser. No. 10/081,460 filed Feb. 21, 2002 and entitled “METHOD AND SYSTEM FOR PROVIDING FOREIGN EXCHANGE PRICE INFORMATION AND HEDGE” the contents of which is incorporated in entirety by reference herein.

### BACKGROUND OF THE INVENTION

1. Field of the Invention

Present invention relates generally to methods and systems for entering into foreign exchange (FX) transactions and, more particularly, to providing hedging of FX exposure.

2. Description of Related Art

With greater regularity, investment companies and other entities are entering into cross-border transactions, each time buying or selling securities in a foreign currency. As such, entities often realize transactions in foreign currencies, and therefore, the accounting records of the entity potentially reflect positions in multiple currencies. Consequently, determining the aggregate value of the positions at any given instant is difficult. A similar problem exists when an entity considers entering into a cross-border transaction. Often, an entity will have the option of entering into the same transaction, for example, the sale of a security, in any one of multiple currencies, thereby receiving bids in multiple currencies. Such option can be meaningless if the entity cannot translate each bid into a common currency. Moreover, when owning securities purchased in a foreign currency, the entity purchasing the securities is exposed not only to typical market risks, but also to the additional risk associated with the FX exposure to the foreign currency. Accordingly, a need exists for a systems and methods for revaluing positions in multiple currencies into a single currency, translating security prices, and removing the FX exposure associated with a transaction.

3. Summary of the Invention

The foregoing, as well as other, needs are satisfied by the present invention. According to certain embodiments, methods and systems for providing foreign exchange price information and entering into foreign exchange transactions are disclosed. In one embodiment, a price provider is electronically coupled to FX rate providers and to clients. The price provider repeatedly receives FX rates, generates FX indicative rates, and provides the indicative rates to the clients. Clients may use the indicative rates to revalue existing positions or translate offers in multiple currencies. Upon receiving a trade order from a client, the price provider generates an FX deal price and enters into a transaction with the client based on the deal price and the trade order.

In certain embodiments the price provider enters into multiple trades with multiple clients. For each such client, the price provider aggregates trades over a period of time and generates an aggregate ticket, thereby reducing transaction costs. More specifically, the price provider may generate an aggregate buy ticket and an aggregate sell ticket for each client.

Furthermore, the system according to certain embodiments is integrated with the clients' order management system, thereby enabling clients to perform real-time price translation of securities trading in different currencies, revaluation of existing positions and removing the FX component to a cross-border transaction.

### BRIEF DESCRIPTION OF THE DRAWINGS

The following drawing figures, which are included herewith and form a part of this application, are intended to be illustrative examples and not limiting of the scope of the present invention.

FIG. 1 is a schematic illustrating the data flow according to one embodiment of the present invention.

FIG. 2 is a database schematic according to one embodiment of the present invention.

FIGS. 3a and 3b are flow charts illustrating operation of the system according to one embodiment of the present invention.

### DETAILED DESCRIPTION OF PREFERRED EMBODIMENTS

### Overview

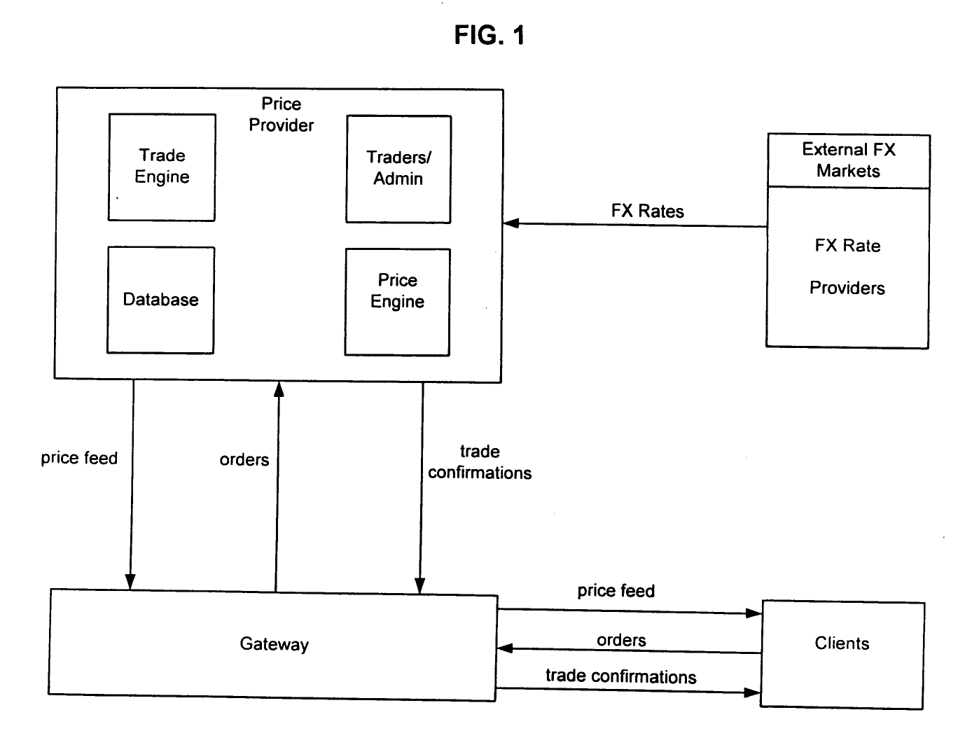

Certain embodiments of the present invention will now be described in greater detail with reference to the foregoing figures. As illustrated in FIG. 1, the present embodiment includes four general components: one or more FX Rate Providers, such as Interbank Trading Platforms; a Price Provider; an electronic Gateway; and one or more Clients. As will be described in greater detail below, the FX Rate Providers provide FX rates to the Price Provider. The Price Provider, in turn, provides indicative FX rates to the Clients, via the Gateway. The Price Provider preferably provides streaming FX indicative rates prices to the Clients via a price feed. The Clients utilize the price feed in any number of ways and, based on FX deal prices established by the Price Provider, may periodically enter into FX trades with the Price Provider.

### Clients

It is to be understood that Clients may use the price feed and interact with the Price Provider of the present embodiment for any number of purposes, including realizing an equity or other transaction in either a local or other currency, or revaluing existing equity positions to a currency of choosing. For example, when entering into an equity transaction, the Client may elect to realize the transaction in the currency of the country or exchange to which the transaction relates (i.e., the local currency) or, by entering into a FX trade with the Price Provider, hedge against or offset the exposure to the local currency. By entering into the FX trade essentially simultaneously with the equity trade, the Client in effect realizes the transaction in another currency. As such, the Client may issue an order via the Gateway to the Price Provider to enter into a FX trade. By way of example, a United States Client entering into an equity transaction on the Canadian Stock Exchange may enter into that transaction paying in Canadian dollars, while simultaneously removing the FX component to that transaction by entering into a U.S. dollar/Canadian dollar FX trade with the Price Provider. In the FX trading vernacular, the Client would have “flattened out” the FX exposure resulting from the cross-border securities transaction. Although the present invention is described in terms of embodiments involving equity trades, the present invention is equally applicable to non-equity transactions.

Additionally, a Client having existing positions in one or more foreign currencies may use the price feed to determine in essentially real-time the value of the positions and, by entering into trades with the Price Provider, to perform a real-time revaluation of foreign currency (i.e., for United States based entities, non-dollarized) positions. It should be appreciated by those skilled in the art that seamless integration of the FX price feed and the ability to enter into FX trades allows the Clients to perform an essentially real-time mark-to-market revaluation of one or more of their positions.

Clients may interact with the system to obtain the foregoing functionality in any number of ways. For example, a Client preferably includes one or more servers or other processors in communication with the Gateway and running order management software (OMS) designed to automatically accept and utilize the Client's price feed and provide the Client with the ability to automatically flatten-out trades or revalue portions. More specifically, the Price Provider may provide developers of the OMS with the application program interface (API) detailing the format and protocol of the price feed, thereby enabling the OMS to extract and integrate into its functionality the indicative FX rates contained in the price feed. Any format in which the denied parameters of the price feed can be passed is within the scope of the present inventor.

### FX Rate Providers

It is to be understood that the reference to FX Rate Providers refers to any Interbank trading platform currently existing or developed in the future. As such, FX Rate Providers may include the platform provided by Reuters Group Plc under the tradenames REUTERS 2000 and REUTERS 3000, the platform provided by The EBS Partnership under the tradename EBS DEALING SYSTEM, and/or other platforms or exchanges. Furthermore, it is to be understood that it is within the scope of the present invention to utilize FX Rate Providers other than Interbank trading platforms.

The FX Rate Providers provide the FX rates to the Price Provider via any of a number of communications systems and protocols. For example, existing FX Rate Providers, such as the Interbank trading platforms noted above, provide such connectivity via a secure network connection known as the tri-arc backbone; however, any communication connection and protocol may be used. Regardless of the particular type of communication used, the Interbank trading platforms or other FX Rate Provider preferably provides the Price Provider with FX rates in essentially real time, as bids and offers are being entered in the external FX market.

### Price Provider

The Price Provider preferably includes a computer system comprising, for example, one or more servers or other processors on which software components providing the functionality described herein reside. The Price Provider system preferably also includes computer workstations coupled to the servers for allowing traders, administration, management or other Price Provider personnel to interact with the System. In the present embodiment, the software components include, in addition to other components providing standard functionality, a Trade Engine and a Price Engine. The Price Engine may comprise one or more components or modules, which may reside on the same or different hardware. As will be described in greater detail below, in the present embodiment the Price Engine applies indicative rate factors to the received FX rates to calculate the indicative rates of the price feed. Similarly, the price Engine applies deal price factors (deal price factors and indicative rate factors generically referred to as factors), which may or may not be the same as one or more of the indicative rate factors, to the FX rates to determine the FX deal prices at which Client trades are executed. The Trade Engine includes those software components and/or systems for providing back-office settlement and clearing functionality, including aggregating trades and issuing trade confirmations and tickets, and for allowing traders of the Price Provider to enter into trades on the external FX market.

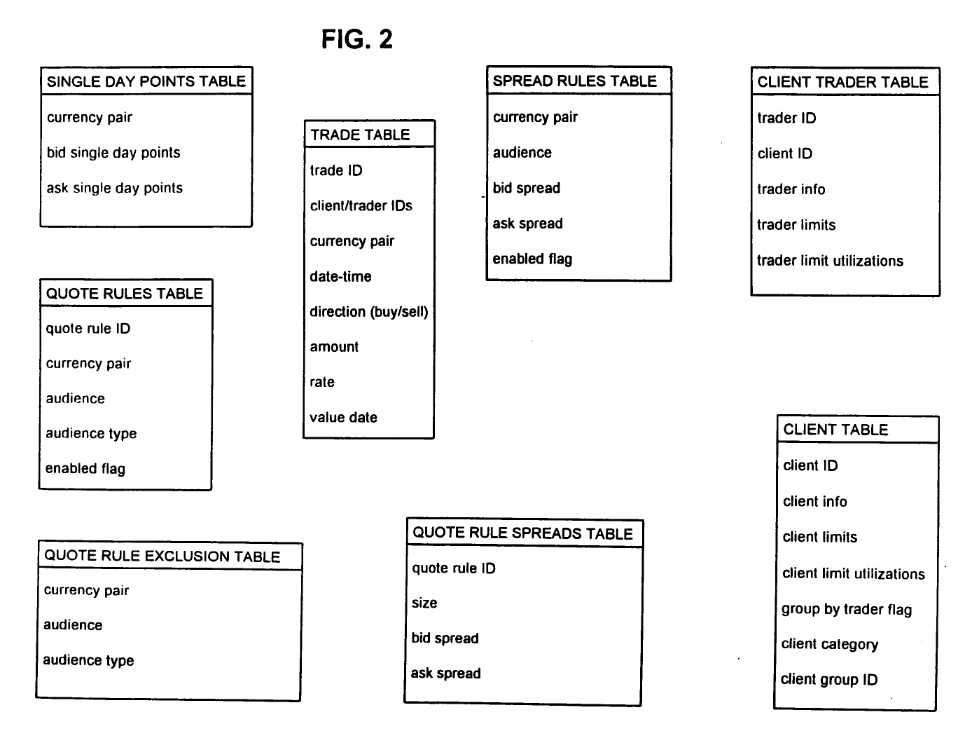

The Price Provider system of the present embodiment also includes an electronic Database (described below with reference to FIG. 2), which may be implemented in any of a number of technologies heretofore or hereafter available.

### Gateway

Although not required, the Price Provider of the present embodiment also operates the electronic Gateway. Furthermore, in the present embodiment, the Price Provider interacts with the Clients via the Gateway using the currently accepted Financial Information eXchange (FIX) protocol. As such, the Gateway is a FIX gateway. However, in alternate embodiments of the present invention, different protocols are used. As such, it is within the scope of the present invention for the Gateway and Price Provider to simultaneously transact with Clients in different protocols. In such embodiments, an additional layer of software exists (at the Price Provider, Gateway, and/or Client) for translating or normalizing the disparate formats and protocols between the Price Provider and each Client.

In the present embodiment, each Client is connected to the Gateway via a dedicated, point-to-point connection or a fixed trading network, such as that provided by Reuters Group, plc, Bloomberg LP, IFX (a subsidiary of Zetters Group, plc), Thompson Financial (under the tradename TRADEROUTE), and the like. Such fixed network connections provide added security. In alternate embodiments, the Gateway is coupled to the Clients via other types of networks and links, including local area networks, wide area networks, virtual private networks and the like. In one such embodiment, the Gateway and each Client has a unique Internet Protocol address and communicates via the TCP/IP protocol.

### Database

The Price Provider's Database will now be described in greater detail with reference to FIG. 2. As an initial matter, it should be noted that the database of the present embodiment is merely an illustrative logical arrangement of exemplary data, as more or less data may be stored in different embodiments and such data may be arranged in fewer or more tables. Furthermore, rather than include a field in a table to represent certain information, the information could also be represented by setting certain flags associated with the record. Additionally, certain descriptors in the tables represent one or more separate fields of information and are used simply for convenience.

The Database includes a Trade Table, which contains the trade information for each trade between a Client and Price Provider, as identified by a trade identifier (ID). Exemplary trade information includes: the identifier of the Client (Client ID) and trader (trader ID) that entered into the trade; a code representing the currency pair; the date and time of the trade; the direction of the trade (i.e., whether the trade or a buy or a sell); the amount of the trade; the value date of the trade; the rate at which the trade was executed; and the like.

The Client Table contains client information for each Client, as identified by unique client ID. Such client information includes, for example: name; address; contact information; and the like. The Client Table also includes one or more trading limits applicable to the Client (“client limits”), as well as a current measure of where the client is relative to each limit (“client limit utilizations”). Such limits may establish a limit for the Client's: aggregate allowed exposure across all currency pairs for each of forward trades and spot trades and for an aggregate of both forward and spot trades; aggregate allowed exposure to individual currency pairs; (both for forward trades and spot trades) aggregate allowed exposure to a particular currency pair having a particular value date; and the like. The client limits may also include netting and non-netting specific limits and limits for option contracts or other types of transactions entered into with the Price Provider. Client limits may also include a date limiting how far forward the client can trade. Furthermore, the Client Table may include a field specifying a date upon which the client limits expire and must be reevaluated.

The Client Table also includes a client group ID that identifies the Client as part of a group of Clients (e.g., a group of related subsidiary companies, a group of trading offices in the same company, and the like). Accordingly, by setting the “group by client group” filed, the limits are based on and compared against the aggregate trading activity of all Clients in a particular group, as identified by client group ID. In an alternate embodiment, such grouping by client category is on a limit-by-limit basis, with each limit having an associate flag to indicate such grouping.

The Client Table of the present embodiment also includes a client category field. This field allows the Price Provider to categorize each Client as to the quality of, or how good a Client it is relative to other Clients. As described below, such categorization may be used in determining indicative rates and deal prices. For example, the Price Provider may, from time to time, categorize Clients according to the volume of trades entered into over a given period, such as monthly or annually, with higher-volume Clients being categorized more favorably (e.g., provided a more favorable FX rate and deal price). In alternate embodiments such categorization is performed on a currency pair basis. Furthermore, such categorization may be as course (such as very good, good, average, poor) or as fine (such as a number based on the Client's trade volume) as the Price Provider desires. For example, such fine level categorization may be a number directly proportional to the relevant trade volume, which may be used in al algorithm to determine the provided FX rates and/or prices to the Client.

The Client Table also includes a “group by trader” field for indicating whether trades should be aggregated for the Client across all of the Client's traders or whether trades should be aggregated for each of the Client's Traders. As described in greater detail below, such aggregation is used by the Price Provider for generating trade tickets. As will be appreciated by those skilled in the art, such aggregation of trades may significantly reduce the number of tickets and, therefore, the Price Provider ticket charges.

The Client Trader Table includes a record for each trader of each Client, as identified by trader ID. Each record includes the ID of the Client with which the trader is associated and trader information, which may include multiple fields of information identifying the trader, such as name, registration, contact information, and the like. The Trader Table may also include trader limits and trader limit utilizations to track the trader's exposure relative to the limits. Trader limits may include anyone or more of the aforementioned client limits or any other limit deemed relevant to the Price Provider or Client. Indeed, Clients themselves may wish to pose limits on their traders, in which case the Price Provider can allow the Clients to set limits during Client registration.

The Database also includes several tables used by the Price Engine in determining FX indicative rates and deal prices. In this regard, the Single Day Points Table includes a record for each currency pair that identifies the Price Provider's one day's forward points to be added to each of the bid and ask for that given currency pair. More specifically, in the present embodiment, the indicative rates in the price feed provided to the Clients are the currency pairs' spot rates, and the one-day forward points which may be used to adjust the spot rate in the event a Client chooses to trade for a value-date other than spot. However, in alternate embodiments the indicative rates may be other rates, as identified to the Clients. In short, the spreads in this table are used in conjunction with the FX rates received from the Rate Providers (which themselves are preferably stored in a continuously updated table, not shown) in determining the indicative rates.

In the present embodiment, Price Provider personnel manually enter the single day points values and update them accordingly, although it is within the scope of the present invention for a separate computer system to automatically calculate the points and populate the table. Furthermore, it is to be understood that use of separate bid and ask points is preferable for added flexibility but is not required, as one value could be used for both bid and ask rates.

The Spread Rules Table also contains data used to determine the indicative rates. More specifically, the table includes records that specify the bid and ask spreads to be provided to each Client for each currency pair. As such, each record specifies the currency pair, the client ID (in the “audience” field) to which the spreads apply, as well as the actual bid spread and ask spread. In the present embodiment, the bid spread is a positive amount to be subtracted from the bid rate received form the Rate Provider, and the ask spread is a positive amount to be added to the ask rate received form the Rate Provider. In alternate embodiments, the Spread Rules Table includes an audience type field for specifying the type of audience (i.e., client, trader, client group, client category), to which the spread applies, in which case the audience field would specify the identifier for the particular audience to which the spreads apply.

In the event the bid and ask spreads are to be applied to all Clients and traders, a predefined code is used in the audience field, thereby signifying universal applicability. Conversely, in the event the system is not to provide rates for a specific currency pair (for example, in response to a command received from Price Provider personnel sent in response to unacceptable market volatility), the systems sets the “enabled” field to indicate the spreads being not enabled. The system recognizes such not enabled spreads/currency pairs and does not provide rates.

The Quote Rules Table is used to determine the FX prices provided to Clients and, more specifically, associates a FX price quote rule to one or more audiences. Each quote rule, as identified by quote rule ID, relates a currency pair, an audience, and an audience type (e.g., Client, Client trader, client category or client group). More specifically, depending upon the audience type, the audience field will specify to whom the quote rule applies. Thus, if the audience type is “client,” the audience field specifies the Client ID to which the quote rule applies; if the audience type is “trader,” the audience field specifies trader ID, if the audience type field is “client category,” the audience field specifies the client category. Additionally, by including a predetermined universal ID in the audience field, the system will apply the quote rule to all Clients. Lastly, the table includes an enabled flag, which indicates whether the currency pair spreads are not enabled and should not be transmitted or used.

The Quote Rules Spread Table, in turn, defines the spreads (and indirectly the deal price factors) associated with each quote rule, as identified by quote rule ID. In the present embodiment, the spreads applied are based only on the size of each order for each Client. In general, the smaller the size of the trade, the larger the spread, although any relationship between size and spread may be effectuated. As such, the Quote Rules Spread Table may have multiple records for a given quote rule ID, each record providing the spreads for a given size. As such, the size field may specify a range or a particular size. If the order falls within the range, the spreads apply. In embodiments where the size field does not specify a range, the range is determined by two records in the table; for example, if the size of the order is less than the size in a first record, but greater than the size in the record with the next greatest size, then the spreads in the first record apply. As with the Spread Rules Table, the Quote Rules Spread Table provides separate spreads for bid and ask prices, although it is within the scope of the present invention to provide the same spread for both prices. Although the present embodiment utilizes size as a deal price factor, alternate deal price factors are described below. By way of non-limiting example, a U.S. Dollar-Japanese Yen trade of fifty thousand dollars may receive a spread of three points outside the indicative rate, while a trade of one million dollars for the same currency pair may receive a spread of one point outside of the indicative rate.

The Quote Rule Exclusion Table includes a record identifying each set of parameters for which the Price Engine is logically turned off, and not quotes are provided. To this end, the table identifies combinations of currency pair, audience and/or audience type for which no quotes are generated by the system.

### Operation

Having described the components of the present embodiment, its operation will now be described in greater detail. Initially, each Client goes through a permissioning or registration process to set its account. For example, each Client will identify relevant traders, providing the necessary identifying information as stored in the database and identify whether trades should be aggregated by trader. Additionally, the Price Provider may require each Client to provide other information pertaining to its credit worthiness, such as debt or counterparty rating, which may be used by the Price Provider in determining what, if any, trade limits should be set on the Client's account. The Client will also provide connectivity information, for example the IP address of its system. Additionally, the Price Provider system assigns the Client Ids and trader IDs and sets trading limits as part of the permissioning process.

Once a Client is registered, it may begin receiving the price feed containing the indicative FX rates. In providing the price feed, the Price Provider continuously receives the FX rates into its computer system from the FX Rate Providers. As noted above, such rates may be continuously entered into a separate table. In general, the Price Engine receives the FX rates of a particular currency pair and, by accessing the Spread Rules Table, determines the spread to be added or subtracted (for asks and bids, respectively) to the received FX rate to determine the indicative FX rate to be provided to each Client in the price feed. The system continuously cycles through each record in the Spread Rules Table, providing the indicative rate for each enabled currency pair. The system of the present embodiment distinguishes price feeds by recognizing who the Client is when it logs on to the system, and then referencing the client category that has been assigned to that Client in terms of spread to apply to indicative rates. It then publishes (for the Clients receiving it) the appropriate indicative rates based on Clients' assigned category.

In the present embodiment, the indicative rates spreads are thus based on the FX rates received from the Rate Providers and the spreads. It is to be understood that the spreads, in turn, may be based on any number of indicative rate factors. Such indicative rate factors may include any market or client factors or information deemed pertinent to the price provider, including, for example; the relative liquidity of the particular currency; the relative volatility of the FX rate of the particular currency pair; the Price Provider's current position in the particular currency pair; and the like. The Price Engine continuously updates the indicative rates based on current FX rates as received from the FX Rate Providers.

In certain embodiments the Price Provider provides the same indicative rates to all Clients, while in other embodiments the Price Provider provides different indicative rates to different clients. In one such embodiment, the Price Engine further adjusts the spread added to or subtracted from the FX rate based on Client-specific indicative rate factors. For example, the Price Provider may be willing to provide a tighter (or smaller) spread for better Clients. In this regard, the Price Engine may, for example, provide a spread that is inversely proportional to a Client's aggregate trade volume in a given time period (e.g., second(s) minute(s), hour(s), day(s), month(s), year(s), and the like), and spreads based on other Client-specific or related information, such as the relative value of the Client to other areas of business in which the Price Provider or a related entity engages. As such, the Price Engine allows the Price Provider to discriminate between Clients actively entering into transactions with the Price Provider and Clients who instead use the system primarily for price discovery.

As discussed below, the Price Engine also operates on the FX rates to determine the FX deal prices at which the Price Provider enters into trades with Clients. In this regard, the Price Engine of the current embodiment adjusts the spread based on the size of the transaction, on a Client-by-Client basis, as determined in the Quote Rules Spread Table. In alternate embodiments, the deal price is based on any other combination of deal price factors, such as: the amount or volume of transactions handled by the Price Provider system in a given time period (e.g., second(s), minute(s), hour(s), day(s), and the like) in the same currency pair as the subject transaction; the amount or volume bid or offered by the system in a given time period (e.g., second(s), minute(s), hour(s), and the like) for the same currency pair as the subject transaction; and any other market or client related information. By including a field in the Traders Table indicating when each trade was entered into, the volume per unit time can be measured. In certain embodiments, the foregoing time periods are different for different currency pairs (e.g., shorter for more volatile currency pairs) and are adjustable by system administrators. As noted above, in certain embodiments, the Price Engine provides the same FX deal price irrespective of the Client and/or transaction while in other embodiments, the deal price will depend, as did the indicative rates, open the Client to which the deal price applies.

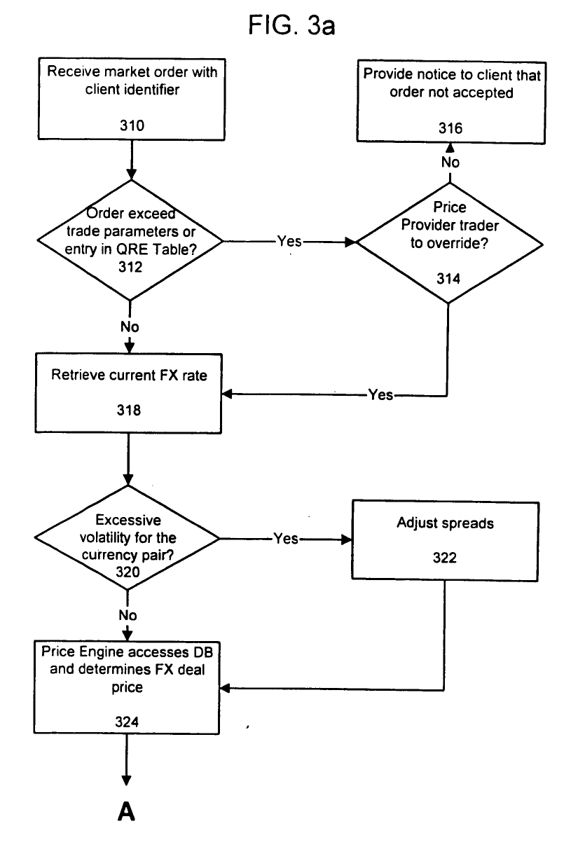

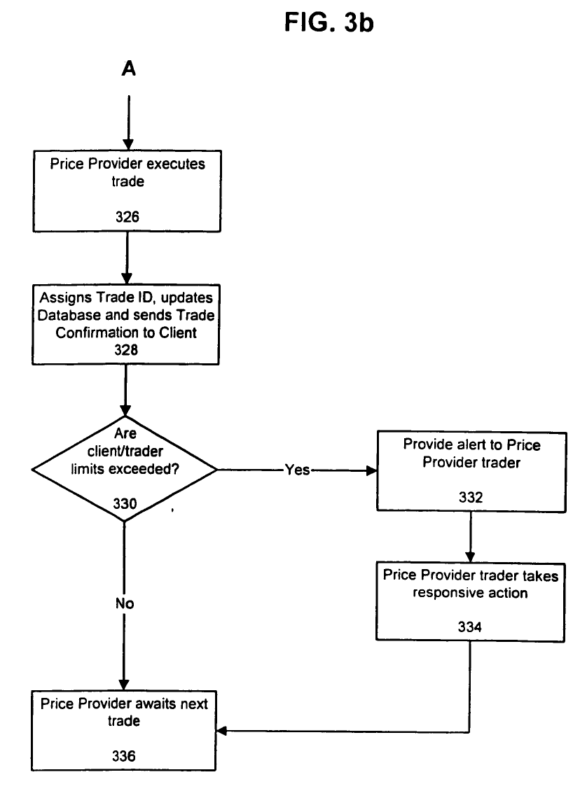

The process of receiving and executing a client order will now be described in greater detail with reference to FIGS. 3a and 3b. Initially, the Price Provider receives a market order containing both trade details as well as the client and/or trader IDs. Step 310. Because the market order is received in the FIX protocol, the Price Provider's system can readily extract the order details and may automatically determine whether or not the order exceeds any trade parameters, and the system determines whether it can quote this transaction by checking the Quote Rule Exclusions Table for an entry corresponding to the order. Step 312. Such trade parameters may include any limit, range or other qualification on any individual parameter contained within the order or combination of parameters contained within the order, including, for example, minimum and/or a maximum size of trades for a particular currency pair and the like. If the system has had more than a certain amount dealt in the same direction, on a particular price or within a certain definable price range it will shade the price accordingly.

In the event the received order exceeds a trade parameter, the present embodiment provides a trader associated with the Price Provider the option to override the system and thereby accept the order. Step 314. If the Price Provider trader does not accept the order, than the system provides notice to the Client that the order is not accepted. Step 316. Alternatively, should the Price Provider/trader determine to override the trade parameters, or if no trade parameter is exceeded, the system proceeds by retrieving the current applicable FX rate. Step 318.

The current FX rate is retrieved for the purpose of the determining the FX deal price at which the trade will be executed. However, prior to applying pre-determined quote rules and spreads to the FX rate, the system first considers then-current market trends and conditions and the Price Provider's own positions. For example, the system may determine whether the applicable currency pair is experiencing excessive volatility. Step 320. This determination is based, for example, on an analysis of completed trades as stored in the database. More specifically, a software component or routine on the Price Provider system may determine the number and/or volume of trades in a given time period for the particular currency pair by aggregating all trades in the Trade Table having a date-time field within a certain range. Should the number or volume of trades for the currency pair exceed a predetermined threshold, the system automatically adjusts the spreads to protect the Price Provider. Step 322. Similarly, the Price Engine can increase the spreads to protect the Price Provider's then current desk position. For example, if the desk is long a particular currency pair, then the Price Engine will show a relatively smaller ask spread and larger bid spread for that currency pair. In another example, if an unexpected event occurs in a particular country that may have an impact on the value of that country's currency (in which case an increase in trade activity and volatility will most likely occur involving that currency), spreads associated with that currency would be widened accordingly until normal market conditions return. Alternatively, these factors are utilized as deal price factors and are already reflected in the deal price.

Adjustment of the spreads may include a predetermined, absolute increase in the spread, a predetermined percentage increase in the spread, or application of a predetermined algorithm to increase the spread, which algorithm may be based, in part, on market conditions. For example, such an algorithm may increase the spread in proportion to the amount of volatility or volume of the particular currency pair. It is to be understood that adjustment of the spreads (and the, indirectly, the deal price factors) is preferably performed on a currency pair-by-currency pair basis, with each currency pair having adjustments tailored to the historical or anticipated volatility of the currency pair. In alternate embodiments, however, the same adjustments may be applied to multiple currency pairs.

Regardless of whether the predetermined or adjusted spreads are to be applied, the Price Provider system proceeds by executing the Price Engine to determine the deal price. Step 324. In general, the Price Engine determines whether there is a particular spread to be applied to the particular trader, Client, Client group or Client category. For trades having a value date beyond spot, the Price Engine also adds or subtracts, for bids and asks, the appropriate one-day forward points.

As noted above, the Price Engine will apply deal price factors to determine the deal price. For example, in the present embodiment, the Price Engine is programmed to access the Quote Rule Spreads Table and provide a relatively larger spread for relatively small sized trades, which themselves would be unmarketable, provide a relatively smaller spread for medium sized trades, which are more marketable, and/or provide a relatively larger spread for large sized trades, which may be relatively illiquid. It is to be understood that the distinction between small, medium and large size trades is made by the Price Provider based on any factors deemed relevant by that Price Provider. For example, such distinctions may be based upon current external FX market condition, such as the perceived market liquidity available in a particular currency pair at any given time, subject to change. Such distinctions may also be based on deal size, for example, with smaller sized trades having relatively wider spreads in order to make sure the profit associated with the trade at least covers the Price Provider's internal processing costs to do the transaction. If the deal is above a certain threshold (that may vary by currency and may be change as market conditions change), the Price Provider may desire to increase the spread to insure that there is enough liquidity within the spread to allow the Price Provider to cover the entire trade.

It is to be understood that although the present embodiment may execute an FX order at a deal price different than the indicative rate provided to the Client, it is within the scope of the present invention to allow the indicative rates provided in the price feed to be used in the Clients' orders. In such embodiments, the Client's OMS may automatically extract the relevant indicative rate from the price feed and incorporate the rate into the Client's market order. Although the present invention applies the deal price factors (and indicative rate factors) looking up entries in a database, it is within the scope of the invention to apply the factors programmatically. For example, the Price Engine may calculate spreads in close to real time by applying the FX rate for the subject currency pair, market conditions, Price Providers desk positions, current and/or historical Client information, or any combination of the foregoing, and deal price factors or indicative rate factors, as the case may be, to an algorithm to determine the deal price or indicative rate, respectively. In certain of such embodiments, each factor is a function of variables comprising the currency pair, market conditions and client information, and the deal prices and indicative rates are functions of the factor functions.

Having determined the applicable FX deal price, the Price Provider executes the trade. Step 326. In the present embodiment, the Price Provider acts as principle, trading on its own account. However, in alternate embodiments, the Price Provider may act as an intermediary to other counterparties. Once the trade is executed, the system assigns a trade ID, updates the database and sends a trade confirmation to the Client. Step 328. Such updating includes adjusting the client limit utilizations and trader limit utilizations.

In the present embodiment, the system also determines whether or not trading limits are exceeding. Step 330. As noted above, such trading limits may include any one or more limits set at the client and/or trader level. Such limits may be based on aggregate Client and/or trader exposure and may be based on a single currency pair, all currency pairs (i.e., total exposure) or a subset of currency pairs. The system thus compares the client and trader limits to the client and trader limit utilizations, respectively. Alternatively, where no utilization fields are used, the system runs a software routine, script, component or program that aggregates the values stored in the Trades Table to determine whether or not limits are exceed. More specifically, the system accesses the Trade Table in the database and aggregates trades contained therein that have the parameters relevant to the limit at issue.

If no trading limits are exceeded, then the Price Provider continues with its normal operation, providing the price feed and awaiting the next trade order. Step 336. On the other hand, if a trading limit is exceeded, the Price Provider system of the present embodiment generates an alert to a Price Provider trader. Step 332. In response, the Price Provider/trader may take any of a number of responsive actions, including immediately executing an off-setting trade, asking for credit permission to exceed the Client's credit limit, or simply refusing the trade. Step 334.

The foregoing description is one exemplary process for responding to market orders. Other suitable processes perform different steps or the same steps in a different order. For example, it is within the scope of the present invention to first receive the order, then determine the spread, and then retrieve the current rates to which the spreads will be applied. Similarly, it is within the scope of the invention to determine whether or not to enter into a trade or to adjust the spreads at any point prior to execution.

Furthermore, it is within the scope of the present invention to receive and act on immediate or cancel orders (IOC), commonly referred to as “fill or kill orders.” In an IOC, the Client specifies the size of the transaction and rate at which the Client wishes to enter into the transaction. If the Price Provider cannot immediately fill or execute the order at the requested terms (or better), the Price Provider does not act on the order (i.e., “kills” it). In general, when the system receives an IOC, the Price Engine determines the spread to be applied, access the raw rates and determines the deal price to be offered. If the deal price meets or is better than the rate specified in the IOC, the IOC is filled. The IOC is not filled if the deal rate does not meet the requested rate. In certain embodiments, prior to an IOC being killed, the system provides Price Provider personnel the option to intervene and adjust the deal price.

In certain embodiments, the Price Provider (e.g., a trader or other personnel) may manually override the Price Engine and adjust the spread on any one or more currency pair such adjustment may be in response, for example, to a panic condition on the overall market or the market for a particular currency. The override, which can be effectuated by entering a command on a workstation, may increase the spread a predetermined amount, a certain percentage of the FX rate, according to an algorithm based on market or other factors, or by an amount manually entered into the system. Furthermore, although such a panic override is preferably applied on a currency pair-by-currency pair basis, in alternate embodiments a panic override that applies to all currency pairs is made available (which may be in addition to a currency panic override).

From time to time (e.g., daily, hourly, twice-daily, and the like), the Price Provider system preferably aggregates trades executed with each Client, issues tickets with each Client reflecting the aggregate of the Client's trades in each direction and enters into trades with the external FX market. In the present embodiment, trades are, by default, aggregated based on five criteria: client ID, currency pair, direction (e.g., Buy/Sell), value date and trader ID. As such, the group by trade field is by default, set. More specifically, the Trade Engine periodically runs a routine or script that causes the Trade Table of the Database to be accessed and each trade for a given set of the foregoing five criteria are aggregated. For example, the system searches the Trade Table for all buy orders of a particular currency pair executed by a particular trader having a particular value date. For each trade identified and aggregated, the system sets a flag or otherwise notes that the trade has been included. Once the trades have been aggregated, the system generates a single buy ticket noting the other criteria. The same process is followed for sell orders meeting the other four criteria, thereby resulting in a single aggregate sell ticket. As such, the Price Provider system has the capability of issuing single buy and sell tickets summarizing trades over any given time period, for example, each hour, day, week, month, or any other time frame.

As noted above, in the present embodiment, the Price Provider is acting as principle, entering into trades with its Clients on the Price Provider's own account. Consequently, the Price Provider may periodically enter into off-setting trades on the external FX market, for example, via Interbank Trading Platforms. However, it should be noted that the ability to aggregate trades entered into with its Clients allows the Price Provider to enter into larger trades on the external FX market, thereby obtaining more favorable pricing than if its Clients attempted to enter into the trades individually on the external FX market. For example, a Client may enter into a hundreds trades in a day with the Price Provider, aggregating one million dollars. Each individual trade would be too small to be marketable on the external market; however, once aggregated by the Price Provider, the Price Provider may approach the external market with a single order that is marketable. In short, the Price Provider may enter into FX trades on the external FX market at a more favorable rate than its Clients could individually and, therefore, the Price Provider may assess a spread smaller than any other price provider with which a Client may enter into a single trade. It should be noted that the Price Provider may further realize the benefits of aggregation by aggregating (for its own purposes) trades across multiple Clients.

In short, the system minimizes processing costs by aggregating trade activity into a minimum number of trade tickets. In one embodiment, the relatively low costs allow the price provider to provide the system to Clients with no transactional fees. Furthermore, the streaming price feed (when integrated into the Client's OMS) allows real-time price translation of securities trading in different currencies, thereby exposing the best price. Moreover, because the system allows Clients to automatically flatten-out trades at a low cost, Clients are not inhibited from locating a security's best price, and entering into cross-border trades to take advantage of the best price.

As noted above, embodiments of the present invention may be coupled with the Client's OMS to allow for real-time price translation of securities trading in different currencies, revaluation of existing positions and removing the FX component to a cross-border transaction. In one embodiment, the client OMS receives the indicative rates via the price feed and stores the received rates for currency pairs relevant to that particular Client. In certain embodiments, the Client's system includes a database that is updated each time an indicative rate for a particular currency pair is received. In alternate embodiments, the indicative rates need not be stored. Once the indicate rates are received, the Client OMS may use the indicative rates for any of the aforementioned functions.

With regard to revaluation of existing positions, the OMS may present the Client with a screen setting forth each current position, including a field for each position indicating the value in U.S. dollars or some other currency selected by the Client, thereby providing real-time revaluation of the positions. The value would simply be calculated by applying the then current indicative rate to the value of the position in the foreign currency.

In certain embodiments, the OMS similarly applies the then current indicative rates to translate the prices associated with received offers (e.g., asks and bids) into a currency selected by the Client. The received offers may be received by the OMS by any suitable means or entered manually by the Client. The OMS may allow the Client to compare multiple offers, each presented in a different currency. For example, if the client seeks to purchase a security listed on both the Canadian stock exchange (in Canadian dollars) and on a European stock exchange (in Euro dollars), the OMS may use the real-time indicative rates to convert each offer into a single currency, for example, U.S. dollars, thereby allowing the client to recognize the better offer or identify the potential for arbitrage. In one such embodiment, the OMS uses the indicative rates to calculate and present to the Client the value of a cross-border securities transaction, while accounting for the cost of entering into an FX trade to flatten out the FX exposure.

Furthermore, in certain embodiments, the Client's OMS may provide the client with the option to automatically “flatten out” the FX exposure resulting from a cross-border transaction. Such flattening out of the FX exposure may occur substantially simultaneously with the Client's offer or after the resultant trade is entered into and may entail entering into any suitable transaction, including, for example, buying or selling a derivative. More specifically, the client would enter the details of its offer into the OMS, and the OMS would automatically recognize the details of the order placed by the Client (or the trade ultimately entered into by the Client) and generate an order to be placed with the Price Provider based upon the details of the order placed by the Client or resultant trade. It should be understood that any one or more of the foregoing and other uses of the indicative rates and price provider system are within the scope of the present invention.

Those skilled in the art will recognize that the method and system of the present invention has many applications, may be implemented in many manners and, as such, is not to be limited by the foregoing exemplary embodiments and examples. In this regard, it should be understood that any combination of indicative rate factors and deal price factors may be used. It is also to be understood that indicative rate factors may include the deal price factors, and vice versa. Such rates may also be applied (e.g., from time to time or in real-time) to determine the one-day forward points. Additionally, the functionality of the components of the foregoing embodiments may be implemented in different manners. For example, the Price Engine may be logically separated into multiple components, one for applying the indicative rate factors and another for applying the deal price factors. In other embodiments, the Price Engine is separated into two components: one for applying client and order-specific factors in determining the rates and prices and another for applying universal rate and price factors. Thus, the scope of the present invention covers conventionally known and future developed variations and modifications to the system components described herein, as would be understood by those skilled in the art.

What is claimed is:

1. A system for revaluing multiple positions associated with multiple currencies, each position having a value in one of the multiple currencies, the system comprising:
one or more processors configured to:
receive an indication of a selected currency in which the positions are to be revalued;
receive indicative rates for the multiple currencies; and
apply the received indicative rates to the values of the multiple positions to revalue the positions into the selected currency.

2. The system of claim 1 wherein the one or more processors are configured to repetitively receive indicative rates and to repetitively apply indicative rates that are most recently received to revalue the positions.

3. The system of claim 1 wherein the one or more processors are further configured to generate a trade offer based on the indicative rates.
